(19) United States
(12) Patent Application Publication
(10) Pub. No.: US 2013/0112000 A1
(43) Pub. Date: May 9, 2013

(54) ULTRASONIC SENSOR

(71) Applicants: Boum Seock Kim, Gyunggi-do (KR); Jung Min Park, Gyunggi-do (KR); Eun Tae Park, Gyunggi-do (KR)

(72) Inventors: Boum Seock Kim, Gyunggi-do (KR); Jung Min Park, Gyunggi-do (KR); Eun Tae Park, Gyunggi-do (KR)

(73) Assignee: SAMSUNG ELECTRO-MECHANICS CO., LTD., Gyunggi-do (KR)

(21) Appl. No.: 13/350,882

(22) Filed: Jan. 16, 2012

(30) Foreign Application Priority Data
Nov. 9, 2011 (KR) 1020110116542

(51) Int. Cl. G01N 29/04

(52) U.S. Cl. 73/644

(57) ABSTRACT

Disclosed herein is an ultrasonic sensor, including: a case partitioning an inner space; a temperature-compensation ceramic maintaining a temperature of a sensor to be constant; sockets accommodating the temperature-compensation ceramic; a negative (−) terminal and a positive (+) terminal connected to the sockets, respectively; a piezoelectric ceramic connected to the positive (+) terminal and vibrating when power is supplied thereto; and an acoustic absorbent absorbing vibration of the piezoelectric ceramic.

### CROSS REFERENCE TO RELATED APPLICATION

This application claims the benefit of Korean Patent Application No. 10-2011-0116542, filed on Nov. 9, 2011, entitled “Ultrasonic Waves Sensor”, which is hereby incorporated by reference in its entirety into this application.

### BACKGROUND OF THE INVENTION

1. Technical Field

The present invention relates to an ultrasonic sensor, and more particularly, to an ultrasonic sensor for a safety device of backward movement of a vehicle, which prevents accidents by sensing obstructions during backward movement of the vehicle.

2. Description of the Related Art

Ultrasonic sensors generate ultrasound from a piezoelectric material that is periodically modified due to voltage applied thereto and use a method of calculating an actual distance to an obstruction by measuring ultrasound that is reflected off the obstruction and is received back by the ultrasonic sensor.

In reality, when a rear detector is installed in a vehicle, the rear detector can detect a rear obstruction. Performance of a current sensor is determined according to two factors.

A first factor is a measurement distance about how far the sensor is capable of measuring a distance. A second factor is a response speed about how long it takes to convert the reflected ultrasound into voltage. Thus, ultrasound is used to manufacture a sensor for rapidly measuring a long distance with improved performance.

The characteristic of an ultrasonic sensor for a vehicle can be changed since the characteristic of a piezoelectric ceramic is changed due to a large temperature difference between summer and winter.

Thus, it is also important to manufacture an ultrasonic sensor that is not relatively sensitive to a temperature to have constant sensing characteristic regardless of a temperature by combining a temperature-compensation ceramic to an inner part of the ultrasonic sensor.

If an ultrasonic sensor is sensitive to a temperature, when a temperature-compensation ceramic is installed in the ultrasonic sensor in order to compensate the sensitivity, the ceramic and a printed circuit board (PCB) need to be soldered together in order to install the ceramic. In this case, a significant amount of time and costs are incurred.

### SUMMARY OF THE INVENTION

The present invention has been made in an effort to provide an ultrasonic sensor for stably coupling components by using a lead line by which an upper electrode and a lower electrode of a temperature-compensation ceramic are divided.

According to a first preferred embodiment of the present invention, there is provided an ultrasonic sensor, including: a case partitioning an inner space; a temperature-compensation ceramic maintaining a temperature of a sensor to be constant; sockets accommodating the temperature-compensation ceramic; a negative (−) terminal and a positive (+) terminal connected to the sockets, respectively; a piezoelectric ceramic connected to the positive (+) terminal and vibrating when power is supplied thereto; and an acoustic absorbent absorbing vibration of the piezoelectric ceramic.

The sockets may each have a tong shape, and the acoustic absorbent may be disposed on the sockets.

An end of the negative (−) terminal may be connected to the case.

An end of the positive (+) terminal may be connected to the piezoelectric ceramic.

The acoustic absorbent may be formed of non-woven fabric and cork.

The piezoelectric ceramic may include a piezoelectric device.

The piezoelectric ceramic may be installed on a bottom surface of the case and vibrate upward.

According to a second preferred embodiment of the present invention, there is provided an ultrasonic sensor, including: a temperature-compensation ceramic maintaining a temperature of a sensor to be constant; sockets accommodating the temperature-compensation ceramic; a negative (−) terminal and a positive (+) terminal connected to the sockets, respectively; and a piezoelectric ceramic connected to the positive (+) terminal and vibrating when power is supplied thereto.

An end of the negative (−) terminal may be connected to a case surrounding an entire sensor.

The ultrasonic sensor may further include an acoustic absorbent disposed on the sockets and absorbing vibration.

An end of the positive (+) terminal may be connected to the piezoelectric ceramic.

The acoustic absorbent may be formed of non-woven fabric and cork.

The piezoelectric ceramic may include a piezoelectric device.

The piezoelectric ceramic may be installed on a bottom surface of the case and vibrate upward.

The sockets may each have a tong shape.

### BRIEF DESCRIPTION OF THE DRAWINGS

FIG. 1 is an exploded perspective view of an ultrasonic sensor according to an embodiment of the present invention;

FIG. 2 is a partial cross-sectional view of an ultrasonic sensor according to another embodiment of the present invention; and

FIG. 3 is a partial perspective view of an ultrasonic sensor according to another embodiment of the present invention.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

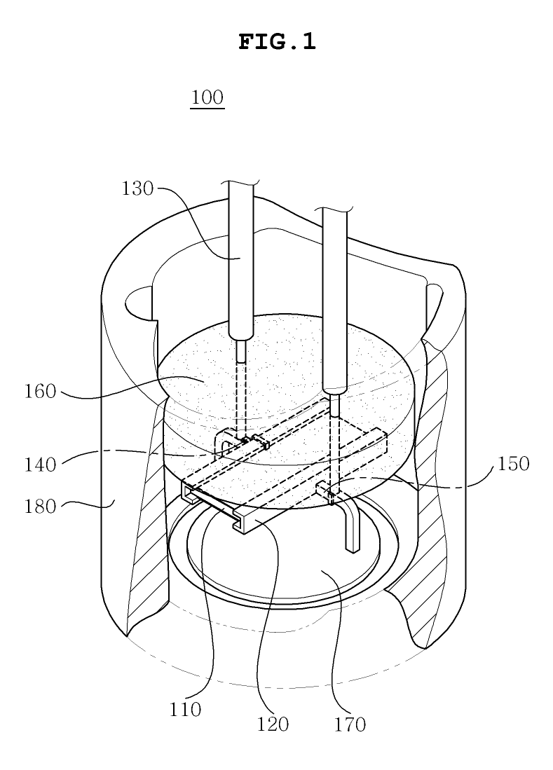

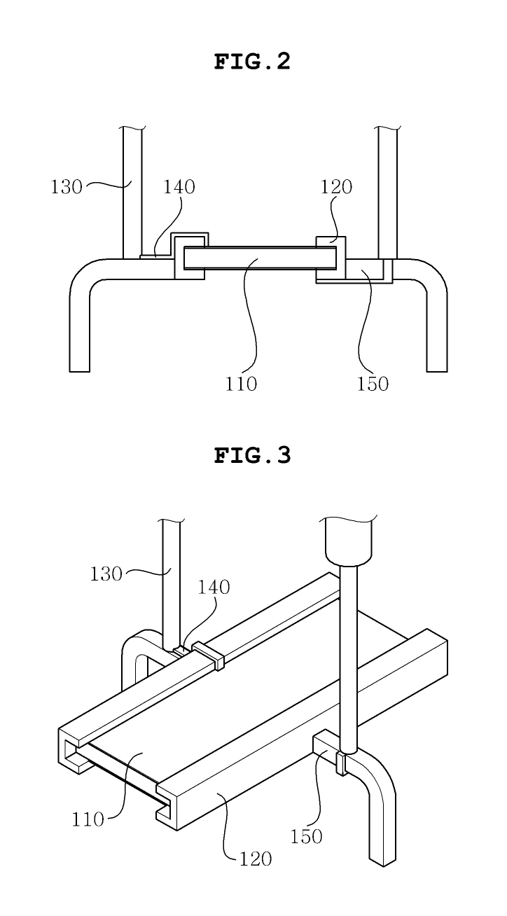

FIG. 1 is an exploded perspective view of an ultrasonic sensor 100 according to an embodiment of the present invention. FIG. 2 is a partial cross-sectional view of an ultrasonic sensor according to another embodiment of the present invention.

FIG. 3 is a partial perspective view of an ultrasonic sensor according to another embodiment of the present invention.

FIG. 1 is an exploded perspective view of the ultrasonic sensor 100 according to an embodiment of the present invention. The ultrasonic sensor 100 includes a temperature-compensation ceramic 110, sockets 120, supports 130, a negative (−) terminal 140, a positive (+) terminal 150, an acoustic absorbent 160, a piezoelectric ceramic 170, and a case 180.

According to the present embodiment, the ultrasonic sensor 100 is a sensor for a safety device of backward movement of a vehicle, which prevents accidents by sensing obstructions during backward movement of the vehicle.

The temperature-compensation ceramic 110 is a ceramic that is capable of compensating a temperature and is not polarized. The characteristic of the ultrasonic sensor 100 may be changed since the characteristic of a ceramic is changed due to a large temperature difference between summer and winter. In this case, in order to compensate for the temperature difference, the temperature-compensation ceramic 110 is installed in the ultrasonic sensor 100.

Thus, the ultrasonic sensor 100 is not relatively sensitive to a temperature to have constant sensing characteristic regardless of a temperature by combining the temperature-compensation ceramic 110 to an inner part of the ultrasonic sensor 100.

The sockets 120 and two sides of the temperature-compensation ceramic 110 are press-fit together, respectively. The negative (−) terminal 140 and the positive (+) terminal 150 are connected to the sockets 120, respectively. The sockets 120 that are respectively connected to the negative (−) terminal 140 and the positive (+) terminal 150 may each have a tong shape and respectively hold the two sides of the temperature-compensation ceramic 110.

In this case, an end of the negative (−) terminal 140 fixed to a first side of the temperature-compensation ceramic 110 is fixed to the case 180. In addition, an end of the positive (+) terminal 150 fixed to a second side of the temperature-compensation ceramic 110 is fixed to the piezoelectric ceramic 170.

The supports 130 are connected to upper portions of the negative (−) terminal 140 and the positive (+) terminal 150, respectively.

When a distance to a subject to be detected is measured by using the ultrasonic sensor 100, the piezoelectric ceramic 170 vibrates by applying a driving voltage to the negative (−) terminal 140 and the positive (+) terminal 150. Due to the vibration of the piezoelectric ceramic 170, a bottom surface of the case 180 vibrates so that ultrasound is radiated in a direction perpendicular to the bottom surface of the case 180.

When the ultrasound radiated by the ultrasonic sensor 100 is reflected off the subject and is received back by the ultrasonic sensor 100, the piezoelectric ceramic 170 vibrates and converts the vibration into an electric signal, and the negative (−) terminal 140 and the positive (+) terminal 150 output the electric signal.

Thus, a distance between the ultrasonic sensor 100 and the subject may be measured by measuring a time interval between applying the driving voltage and outputting the electric signal.

The acoustic absorbent 160, which is embedded in the case 180 to absorb and attenuate vibration, is disposed on the sockets 120. The acoustic absorbent 160 may be mainly formed of non-woven fabric and cork.

The acoustic absorbent 160 does not contact the piezoelectric ceramic 170 directly due to the sockets 120, thereby facilitating free vibration of the piezoelectric ceramic 170.

The piezoelectric ceramic 170 includes a piezoelectric device and generates ultrasound to an entire inner surface of the case 180. When power is supplied to the piezoelectric ceramic 170, the piezoelectric ceramic 170 generates ultrasound and vibrates upward and downward.

That is, the piezoelectric ceramic 170 deflates or inflates due to the driving voltage applied from the negative (−) terminal 140 and the positive (+) terminal 150 to generate vibration. Due to the vibration of the piezoelectric ceramic 170, the bottom surface of the case 180 vibrates so that ultrasound is radiated in a direction perpendicular to the bottom surface.

The case 180 protects the ultrasonic sensor 100 from the outside of the case 180 and partitions an inner space.

The acoustic absorbent 160 is embedded in the case 180. The temperature-compensation ceramic 110 fixed by the sockets 120 is disposed below the acoustic absorbent 160.

The material and shape of the case 180 are not particularly limited. In general, the case 180 may be formed of a material resistant to external shocks so as to easily accommodate the acoustic absorbent 160, the temperature-compensation ceramic 110, and the piezoelectric ceramic 170.

The temperature-compensation ceramic 110 and the piezoelectric ceramic 170 are each a ceramic that is not polarized. That is, even though voltage is applied to the temperature-compensation ceramic 110 and the piezoelectric ceramic 170, the sizes of the temperature-compensation ceramic 110 and the piezoelectric ceramic 170 are not changed.

FIGS. 2 and 3 are a partial cross-sectional view and a partial perspective view of an ultrasonic sensor according to another embodiment of the present invention. As shown in FIGS. 2 and 3, the temperature-compensation ceramic 110 is press-fit by the sockets 120. The temperature-compensation ceramic 110 may have, but is not limited to, a tetragonal shape so as to be easily press-fit by the sockets 120 that are each have a tong shape or a “ [symbol] ” shape.

The negative (−) terminal 140 and the positive (+) terminal 150 are connected to the sockets 120, respectively. Ends of the negative (−) terminal 140 and the positive (+) terminal 150 are connected to a case (not shown) and a piezoelectric ceramic (not shown), respectively.

When a distance to a subject to be detected is measured by using the ultrasonic sensor, the negative (−) terminal 140 and the positive (+) terminal 150 apply a driving voltage to the piezoelectric ceramic (not shown) connected to the end of the positive (+) terminal 150 so that the piezoelectric ceramic (not shown) may vibrate.

Due to the vibration of the piezoelectric ceramic (not shown), a bottom surface of the case (not shown) vibrates so that ultrasound is radiated in a direction perpendicular to the bottom surface.

In a conventional ultrasonic sensor as a rear detector, a conductive metal case is attached to a piezoelectric ceramic and ultrasound is generated by applying voltage to a lead wire.

In this case, the piezoelectric ceramic is a single-layer type ceramic and is attached to a bottom surface of aluminum (Al) case by using conductive epoxy. The piezoelectric ceramic is attached to the bottom surface of the Al case by using conductive epoxy. Non-woven fabric is filled in a portion above the piezoelectric ceramic in order to absorb vibration energy of ultrasound to reduce a vibration time and to protect inner components.

A circuit board serving as a terminal for connecting a cable and a wire is disposed on the non-woven fabric. In general, a temperature-compensation capacitor is disposed on the center of the circuit board in order to reduce a change in sensitivity to external temperature.

Silicon injection molding is performed on a space other than the non-woven fabric and the circuit board in order to protect components and to shield vibration. Due to such positions of the circuit board and a temperature-compensation ceramic, it is difficult to handle equipment, and thus it is very difficult to mass produce ultrasonic sensors and to obtain automation.

In addition, due to the temperature-compensation ceramic used in all processes, soldering that causes serious difficulty in mass production and automation is additionally performed five times.

According to the present invention, instead of a conventional manufacturing method of a sensor cell, in which a temperature-compensation ceramic and a cable of a circuit board are soldered together, two sides of the temperature-compensation ceramic 110 are respectively fixed by the negative (−) terminal 140 and the positive (+) terminal 150, and thus components may be stably inserted into the case (not shown).

The ends of the negative (−) terminal 140 and the positive (+) terminal 150 that are respectively fixed to the two sides of the temperature-compensation ceramic 110 are coupled to upper electrodes of the case (not shown) and the piezoelectric ceramic (not shown).

Accordingly, processability and automation may be largely improved compared to a conventional attaching method using a circuit board, thereby facilitating mass production of goods and reducing automation time.

In addition, an acoustic absorbent does not contact a piezoelectric ceramic directly due to the sockets 120, thereby reinforcing a vibration force.

Although the preferred embodiments of the present invention have been disclosed for illustrative purposes, they are for specifically explaining the present invention.

Therefore, an ultrasonic sensor according to the preferred embodiments of the present invention is not limited thereto, but those skilled in the art will appreciate that various modifications and alteration are possible, without departing from the scope and spirit of the invention as disclosed in the accompanying claims.

Accordingly, such modifications and alterations should also be understood to fall within the scope of the present invention. A specific protective scope of the present invention could be defined by accompanying claims.

What is claimed is:

1. An ultrasonic sensor, comprising:
a case partitioning an inner space;
a temperature-compensation ceramic maintaining a temperature of a sensor to be constant;
sockets accommodating the temperature-compensation ceramic;
a negative (−) terminal and a positive (+) terminal connected to the sockets, respectively;
a piezoelectric ceramic connected to the positive (+) terminal and vibrating when power is supplied thereto; and
an acoustic absorbent absorbing vibration of the piezoelectric ceramic.

2. The ultrasonic sensor as set forth in claim 1, wherein the sockets each have a tong shape, and the acoustic absorbent is disposed on the sockets.

3. The ultrasonic sensor as set forth in claim 1, wherein an end of the negative (−) terminal is connected to the case.

4. The ultrasonic sensor as set forth in claim 1, wherein an end of the positive (+) terminal is connected to the piezoelectric ceramic.

5. The ultrasonic sensor as set forth in claim 1, wherein the acoustic absorbent is formed of non-woven fabric and cork.

6. The ultrasonic sensor as set forth in claim 1, wherein the piezoelectric ceramic includes a piezoelectric device.

7. The ultrasonic sensor as set forth in claim 1, wherein the piezoelectric ceramic is installed on a bottom surface of the case and vibrates upward.

8. An ultrasonic sensor, comprising:
a temperature-compensation ceramic maintaining a temperature of a sensor to be constant;
sockets accommodating the temperature-compensation ceramic;
a negative (−) terminal and a positive (+) terminal connected to the sockets, respectively; and
a piezoelectric ceramic connected to the positive (+) terminal and vibrating when power is supplied thereto.

9. The ultrasonic sensor as set forth in claim 8, wherein an end of the negative (−) terminal is connected to a case surrounding an entire sensor.

10. The ultrasonic sensor as set forth in claim 8, further comprising an acoustic absorbent disposed on the sockets and absorbing vibration.

11. The ultrasonic sensor as set forth in claim 8, wherein an end of the positive (+) terminal is connected to the piezoelectric ceramic.

12. The ultrasonic sensor as set forth in claim 8, wherein the acoustic absorbent is formed of non-woven fabric and cork.

13. The ultrasonic sensor as set forth in claim 8, wherein the piezoelectric ceramic includes a piezoelectric device.

14. The ultrasonic sensor as set forth in claim 8, wherein the piezoelectric ceramic is installed on a bottom surface of the case and vibrates upward.

15. The ultrasonic sensor as set forth in claim 8, wherein the sockets each have a tong shape.
